(19) United States
(12) Patent Application Publication
(10) Pub. No.: US 2004/0009607 A1
(43) Pub. Date: Jan. 15, 2004

(54) Quantum subatomic devices and methods for identifying characteristics of organic and inorganic materials

(76) Inventor: David A. Goodman, Chicago, IL (US)

Correspondence Address: QUANTUM BIOMOD CORPORATION, 954 W WEBSTER AVE, BASEMENT, CHICAGO, IL, 60614, US

(21) Appl. No.: 10/618,330

(22) Filed: Jul. 11, 2003

Related U.S. Application Data
(60) Provisional application No. 60/395,119, filed on Jul. 11, 2002.

(51) Int. Cl. G01N 21/00

(52) U.S. Cl. 436/164

(57) ABSTRACT

An apparatus for the analysis of field differentials, energy/frequency/amplitude modulations, and phase shifts of quantum subatomic particles and collections of matter and other forms of energy. The apparatus comprises subatomic particle distinctions from coherent and incoherent sources and combinations of particle and wave sources including forms of detection. Of which differentials and similarities can be utilized for discrete and non-discrete analysis of organic and inorganic matter.

### CROSS-REFERENCE TO RELATED APPLICATIONS

The present application claims priority from provisional patent application 60/395,119 filed Jul. 11, 2002, which is incorporated herein by reference.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

The present invention relates to identifiable structural compositions and characteristics of matter based on quantum subatomic correlations of deterministic values and propagations. By analyzing these values or propagations, novel comparisons can be expressed in multiple formats for obtaining more finite signal, energy, and particle interactions. Finite quantum values can then be used for classifying or identifying better methodological approaches and for developing tools involving forms of communication(s), data, chemistry, biology, mathematics and physics.

Novel approaches towards utilizing energy and particle relationships to encompass a wide range of understanding in research or product commercialization can be greatly enhanced with these quantum subatomic devices and methods. The current state(s) of which chemical bonds regarding, but not limited to, covalent, ionic, and H+ are obtained or utilized in research or product discovery and exploitation can be enhanced under a more specified and discrete quantum particle differential or propagation analysis. Most currently known relationships of particles and energy are limited to material correspondence within gravitational, electromagnetic, (electrostatic/weak) and nuclear (strong) fields. Manipulation of the composition regarding matter in a paradigm based on the previously mentioned bonds and fields, leave an in deterministic core lacking finite particle mass or energy. In fact the mathematical representation of-this core within existing particle energy paradigms reverts back to Planck's constant of hv. Reoccurring themes in physics and philosophy have in many ways tried to connect the “quantum phenomena” which correlates back to that indeterminism at the core of the paradigm in conjunction to classical physics. Inadvertently quantum conditions ruled by or in association with classical physics caused inadequate mathematical explanations. As a result disabling researcher(s) or product manufacturer(s) from obtaining structural knowledge for advancing their activities. By applying a multidimensional factor and zero resolution constant for an angle in which determining finite particle energy and periodicity in quantum can be achieved. Also overlaps somewhat with Planck's constant but altering it into an orthogonal linear angle still justified in classical and can be mathematically derived and proven. Taken into affect this also embodies Hinesburg's uncertainty principle of localization and particle interaction to be no longer a necessity in providing optimal mediums of energy or particle expressions and understandings. The discrete anomaly of macro atomic energy field differentials and applications of which devices may be derived can be obviously conditioned by the quantum subatomic variance in particle emissions. The particle characteristics observed and energy qualifications for an overwhelming influence of quantum over powering gravity, electromagnetic/weak, and nuclear/strong fields is obtained by the demonstration of quantum subatomic particles bound to other quantum subatomic particles non existent in currently defined energy fields, manipulating macro atomic particles with an observed alteration to known relationships inside of classical physics models. This ability of field degradation encompasses a much wider condition(s) of wave particle classifications involving the currently defined spectrum. It also enables a more precise yet broader manifestation of photoelectric and magnetic devices along with their capabilities. Radiation being one of the characteristics applicable to altering the previously defined condition of the spectrum by changing particle size and field modulations out of a linear progression which goes beyond the known or what is currently active in the public domain.

The operability to alter the linear relationship of particle size in accordance to its predicted amplitude modulation, frequency modulation, or phase modulation at specified moments to un modulated waveform dimensionally shifting emissions and energy specifications. In return modifications of electromagnetic mediums where positive and negative polarity controllers were designed and dictated by electromagnetic fields no longer applies. Quantum subatomic conditions can override those regulations enabling features of like and unlike charged particles attracting and repelling simultaneously to an nth degree of field degradation and dimension shift. Hence controller design can be more accommodating for higher precision and accuracy. In specific, photoelectric controllers phase shift of photons was never given that foundation in design. Not to mention polarized storage devices, conductors, superconductors, etc also halt privy to design enhancement. Most of all currently used technology falls under the origin of Claude Shannon's algorithm in which binary nomenclature was birthed. Limitations to technological advancements became victims of bits and bytes and the propagation of devices utilizing this as the foundation of design. Super symmetrical studies and utilities began to incorporate string theory as outlet our explanation for quantum phenomena that could be observed randomly but never proven in a viable experiment. Acting under inhibitions that classical physics was superiorly proven the quantum phenomena was treated as though it doesn't exist but yet occurs. This was due to the repression of new forms in mathematics intercepting and solving expressions of entanglement. Optical super symmetrical effects render symptoms of entanglement in which by making field degradation insolvent. In any system of varying or like particles, determining the most finite particle or shroud of mass would seem impossible. Hence an in deterministic value was created for exploration of energy units. Proper implementation of multidimensional factors with zero resolution constants for angular particle measurements of interference within periodicity, can enable a locality of finite particle mass and energy with field degradation and polarity continuum. Applied to multiple particle states (super positioning) in a stabilized environment can enable massive control for macro atomic, and subatomic discreteness for analysis of organic and inorganic materials.

### BRIEF SUMMARY OF THE INVENTION

The present invention consists of a specially calibrated gallium argon ion (GaAr⁺) laser that produces a beam. The beam is split at 45 degrees by a proprietary diamond-like carbon (DLC) beam splitter. The optical coherence of the split beams remain super-symmetrically connected even though the photons that comprise the beams travel 45 degrees apart after the splitter.

When the photons interact with a sample, such as DNA or protein, subatomic particle interference is noticeable because of the super-symmetrical effect between the photon streams. An image of this interference is produced and captured. This processes requires no pre-sample dying, staining, or gel preparation. Further, the assay is accomplished without damaging the sample, which is important because it enables, for example, continuous imaging throughout the entire cell cycle.

The image data is sent to the interface device for analysis. The algorithms of the interface device yield the physical manifestation of data derived from the image. The interface device translates the optical data from the image into informatics. The informatics is then further analyzed by a proprietary software application. This yields finished data detailing super-positioned polar differentials of sub-atomic particles in the sample. As desired, additional algorithms can further manipulate this data to produce results in a user-specified, quantitative format.

This screening technology is far superior to other assay methods currently available. Full proteomics or genomic expressions can be analyzed far more discretely using this technology. Binding capabilities and conformational changes can be ascertained much more precisely. The screening of chemical compounds for their pharmacological activity dates back 40 years. The methodologies employed for screening have improved with time in terms of the throughput and in the information derived from the screen. However, the pharmaceutical and biotech industries have a pressing need for new ways in which to measure interactions. Advancement of the present invention could ultimately lead to a better understanding and enhancement of how compound libraries are screened, and determining which compounds should be followed.

### BRIEF DESCRIPTION OF THE SEVERAL VIEWS OF THE DRAWING

FIG. 1 is a block diagram of the invention.

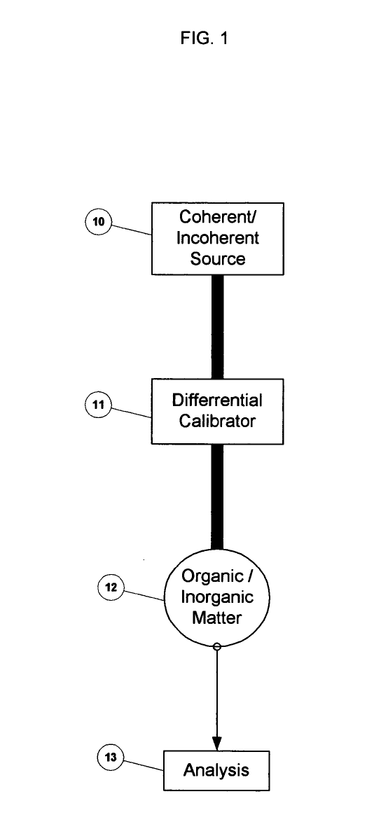

FIG. 2 is a block diagram of a preferred embodiment of the invention where the coherent / incoherent source is split and used to image, analyze and store the data of a sample.

### DETAILED DESCRIPTION OF THE INVENTION

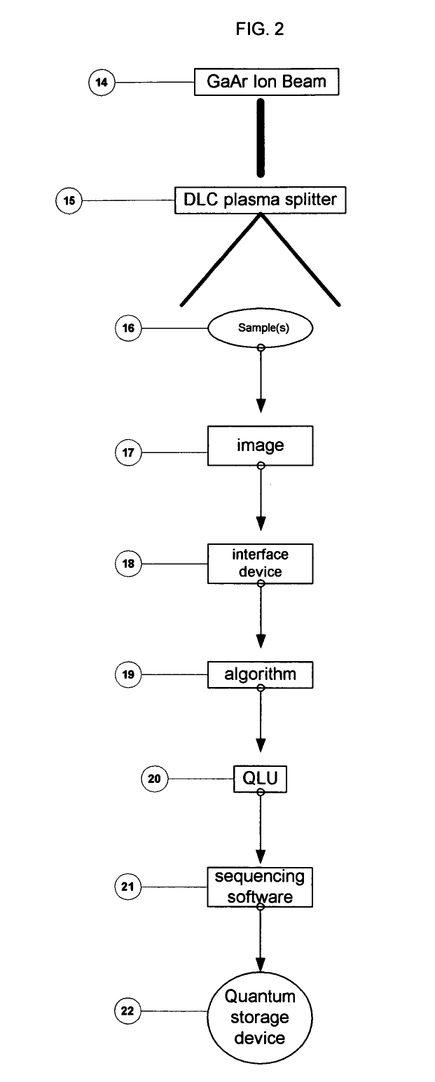

The descriptions below, using a specific type of laser and generated beam is stated as exemplary of the large class of lasers and beams alternatively available to anyone versed in the art. Using this laser/beam as example does not preclude the use of any other appropriate lasers or beams. They are intended to be included under the scope of this patent. Analogously, the exact mechanisms that describe or associate with the ions, isotopes or photons are not limited to the precise functions described by this example explanation. This invention is meant to encompass all such types of lasers, ions, isotopes and photons. It is also to be understood that the explanation given for the phenomenon being described constitute the contemporary best understanding by this inventor for empirically observed experimental behavior. If theoretical explanations for these phenomena are interpreted differently by different theorists at different times, those differences in interpretation do not diminish the novelty and utility of this patent. Phenomological explanations given hereunder are meant to elucidate plausible process for purposes of comprehension and such explanations are not meant to limit the scope of this patent. A block diagram of a preferred embodiment of the invention is shown in FIG. 2 The laser demonstrating the subatomic correlation to photons passing through the sample of inorganic or organic material (such as DNA) is chemically comprised of a Gallium (−) isotope surrounding an Argon (+) isotope. When the Argon is excited and its electrons begin to fluoresce, the states within an energy interval begin to alter in the Gallium. The GaAr ion beam 14 exhibits a continuous blue wavelength of radiation unlike most blue wavelengths because of its specific energy per nanometer and it phase modulation properties. Quantum subatomic particles are activated by the absorption of energy from the fluoresced gallium by the argon per energy interval. The optically directed particles begin to travel superpositioned due to the subatomic particle shift and interconnectivity around the photons. The photons are entangled supersymmetrically within the beam's field. The calibration of the subatomic differentials is accomplished via a DLC plasma splitter 15 consisting of supersaturated hydrocarbons contained by a diamond-like carbon (DLC) crystalline film. After the superpositioned photons leave the splitter, the subatomic particles surrounding the photons begin to attract to each other. Both beams are then supersymmetrically held together at different physical particle localities. Upon entering the sample 16, one beam will influence the other. The distance the photons are allowed to travel is also dependant on the relationship between the beams. Phase shifts, modulations, and altered energy specifications of the sample caused by the beam entering it can also be noticed by the beam not physically interacting with the sample. Analysis of the sample can then be measured for electron differentials as well as subatomic differentials. One method of analyzing these differentials can be accomplished through imaging techniques. As the beams pass through the samples, they can create an image, 17. Multidimensional images of the particles are far more precise and discrete than any ever done before. When applied to measuring at a phase modulation of less than 0.08965, differentials within genetics can be obtained. The differentials of a diseased cell are clearly distinct from the differentials of a non-diseased cell. Many other comparative analyses may be done such as chemical binding, chemical structures, physical structures, dimensional energy patterns, etc. In fact, any form of measuring gravitational, electromagnetic (weak), and nuclear (strong) fields can utilize this invention. The measured differentials producing the image can be captured optically at different shutter speeds by an interface device 18. If the interface device shutter speed is at least 13.6 picoseconds, the differentials in genetic attributes are quite visible. These attributes are then captured and categorized by “Quantum Biological Modulated” algorithm 19 and computed by a Quantum Logic Unit (QLU) 20. This creates the physical manifestation of non-binary data. The data is then filtered in the sequencing software 21 for phenotypic or genotypic traits. The complexity of these traits creates a vast amount of data, which is stored in a quantum storage device 22 at nth polarity of field degradation. Once the genetic location of the subatomic differentials are obtained, the phase shift and field impedances of the occurring disease can be manipulated by the split beam not in physical contact with the sample, or by another similar form of entanglement. It is noted that the test samples used and data collected under the described system can be applied to interrogate virtually any matter or energy configuration. This patent is meant to include all such applications with sub-breakdowns of specific sample types like organic, biological, flora, fauna, chemical, mineral, plasma, particle, or wave.

What is claimed is:

1. A device comprising a coherent or incoherent light source which emits light through and around a sample material, a differential calibrator, and analysis components.

2. The device of claim 1 performs this optical analysis by indirectly screening for the binding affinity of compound\materials without interrupting or perturbing the electromagnetic field of the sample being analyzed.

3. The device of claim 1 produces the data of affinity derived instantaneously, unlike all other methods currently used.

4. The device of claim 1 upon analyzing organic compounds in the form of proteins and or DNA the data derived can be used in determining Target Receptors for Biotechnology or Pharmaceutical Drugs.

5. The device of claim 1 produces data that can also be used to pre-screen entire protein libraries greatly reducing the time of protein and or DNA binding affinity informatics.
